(19) United States
(12) Patent Application Publication
(10) Pub. No.: US 2005/0189066 A1
(43) Pub. Date: Sep. 1, 2005

(54) Laminated cards and methods of manufacture for secure applications

(76) Inventors: Tom Look, Shanghai (CN); Huimin Sun, Northfield, MN (US); Cam Van Nguyen, Brooklyn Park, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/972,941

(22) Filed: Oct. 25, 2004

Related U.S. Application Data
(60) Provisional application No. 60/514,809, filed on Oct. 27, 2003.
(60) Provisional application No. 60/613,969, filed on Sep. 28, 2004.
(60) Provisional application No. 60/514,808, filed on Oct. 27, 2003.

(51) Int. Cl. B32B 31/00

(52) U.S. Cl. 156/277; 156/308.2; 156/387

(57) ABSTRACT

The present invention provides apparatuses and methods for making laminated cards or other secure or non-secure documents using low cost materials, and low cost hardware that is commonly available by means of an easy to use system. Apparatuses and methods of the present invention can produce a quality product for low durability or high durability applications. The present invention addresses certain inadequacies of current laminated cards such as driver licenses or other secure or non-secure documents, production materials, and methods.

This application claims the benefit of U.S. Provisional Application Ser. No. 60/514,809, filed Oct. 27, 2003, entitled “SECURE INSTRUMENTS AND METHODS,” and U.S. Provisional Application Ser. No. 60/613,969, filed Sep. 28, 2004, entitled “LAMINATED CARDS AND METHODS OF MANUFACTURE,” and U.S. Provisional Application Ser. No. 60/514,808, filed Oct. 27, 2003, entitled “LAMINATED CARDS AND METHODS OF MANUFACTURE,” which applications are incorporated herein by reference in their entirety for all purposes.

### TECHNICAL FIELD

The present invention generally relates to laminated cards and methods of making such cards. More particularly, the present invention is directed to laminated cards such as identifying and licensing cards and methods of making such cards in a secure manner.

### BACKGROUND

Many entities such as governmental authorities, businesses, and the like have many needs for licensing and identification devices and production and control of such licensing and identification devices. Some areas where such licensing and identification devices are used include vehicle licensing, vehicle registration and ownership, payment recording, weapons licensing, trade or professional practice licensing, personal identification and certification, birth recording and certification, as well as many others. Such licensing and identification devices may take the form of license plates, vehicle titles, driver licenses, receipts, weapons permits, work licenses, identification cards, and birth certificates. Issuers and users of such licensing and identification devices desire to monitor such devices and their production in order to prevent activities such as tampering, counterfeiting, illegal production, and forgery, for example.

Driver licenses have been made for many years using several different methods. Early driver licenses were handwritten and often included an imprinted seal for security. With the advent of the typewriter, driver licenses were typed on paper and often included some sort of printed background to add security. Such background security became a business in itself with companies furnishing “safety paper” to be used for secure documents. As computers became common, driver licenses could be made with a dot matrix printer driven by a computer. Some jurisdictions added a picture of the licensee by adhering the picture to the paper driver license with a pressure sensitive adhesive. This type of driver license was not very durable and was generally easy to forge or alter because “safety paper” did not add much security.

Another type of driver license was made from photographic stock where the driver image and the driver information were all printed to such photographic stock. The facial image and driver information were usually separate and overlaid optically to form the driver license. Some of the photo driver licenses used a clear polymer top film often applied with some sort of security feature such as a clear hologram or lenticular imaging. Photographic systems were made for both central issued driver licenses and distributed production at many locations in a jurisdiction.

Today most driver licenses are produced using dye diffusion thermal transfer printers on vinyl or other polymer stock. Such licenses are often called a hard card. The facial image and driver information are in the form of electronic data, which is formatted in a computer and downloaded to a dye diffusion thermal transfer printer. The printer uses a panel ribbon comprising the primary colors, including black, to print directly on the vinyl substrate. The process is very exacting with most printers having a surface cleaning means before printing starts to assure a quality print. Most also now use some sort of top protection such as a clear layer provided over a printed layer or a clear polymer sticker applied to the printed surface of the driver license. Both the base vinyl and the top protective layer quite often have some sort of security feature built in.

The security of driver licenses and the production methods used to make such licenses has increased over time. A handwritten driver license can be very easy to forge or alter while a hard card is typically much more difficult to either forge or alter. Still, in most jurisdictions forged driver licenses are easy to obtain because the equipment to make them is readily available. Because the process is not difficult, many forgers make fake driver licenses. A forger may not be able to exactly duplicate the security features but for certain activities such as check cashing or for obtaining age-restricted products such as alcohol or tobacco, or the like, such forged driver licenses may work for these purposes.

The hard card systems today that produce secure driver licenses are often expensive to acquire and the materials used to make the documents are generally expensive. This may be caused by the assumption that system complexity is the best way to stop the fraudulent production of documents. Complexity is not only more expensive but the maintenance of the system is normally greater. Typically, hard card printers are known for frequent breakdowns and high maintenance. Base card stock, dye diffusion panel ribbons, cleaning ribbons and the clear layers or clear polymer stickers are all consumables used to make a driver license and can be expensive. The process is also slow in that a base card makes a separate pass for the cleaning, printing, and the top protection steps. This can mean that the process may use as many as six passes and perhaps over a minute of time. The hardware and maintenance is also expensive in that it is complicated hardware and can be trouble prone.

### SUMMARY

The present invention provides apparatuses and production methods for making laminated cards or other secure or non-secure documents using low cost materials, and low cost hardware that is commonly available by means of an easy to use system. Apparatuses and methods of the present invention can produce a quality product for low durability or high durability applications. The present invention can be used to make laminated cards such as driver licenses or other secure or non-secure documents. Preferably, such secure laminated cards include one or more security features such as area symbologies or bar codes or the like.

In one aspect, the present invention provides an apparatus for making a laminated card. The apparatus preferably includes a carrier for carrying a card in a machine direction and facilitates a supply of a polymer film to be laminated to the card. The carrier provides for better alignment of the polymer film and the card as the polymer film and the card pass through a heater for heating the polymer film and a laminator for laminating the polymer film to the card. Preferably, the laminator comprises at least one roller for applying pressure to the polymer film. The apparatus may include a cooler for cooling the laminated film after being laminated by the laminator.

In another aspect of the present invention, an apparatus for coating a card is provided. The apparatus preferably includes a carrier for carrying a card in a machine direction. The carrier comprises a pocket for holding the card. The apparatus also includes a transfer ribbon comprising a coating material to be applied to the card and a thermal transfer print head positioned with respect to the ribbon for transferring the coating from the ribbon to the card. The apparatus may also use a heated roll positioned with respect to the ribbon for transferring the coating from the ribbon to the card

In another aspect of the present invention, a method for laminating a card with a film is provided. The method comprises the steps of providing a card, aligning a film to be laminated to the card with respect the card, heating the aligned film with a heater, and applying pressure to the film with a laminator to laminate the film to the card. Preferably, the step of aligning the film to the card comprises positioning the card and the film in an alignment device. The step of aligning the film to the card can, however, include attaching the card to a carrier. Also, preferably, the step of applying pressure to the film comprises rolling the film with at least one roller to laminate the film to the card. In another aspect, the method may include a step of protecting the film while applying pressure to the film by positioning a protective layer between the film and the laminator. In yet another aspect, the method may include a step of digitally printing the card before laminating the card.

The present invention provides many advantages. For example, consumables used to make laminated cards of the present invention are generally less costly than consumables used in conventional hard card systems. Also, the present invention can use hardware that is generally less costly, easier to maintain, easier to use, and readily available, as compared to that used by conventional hard card systems. Another advantage is that printer resolution of systems of the present invention can be higher than that of previous systems such as conventional hard card systems. The types of card stock material and thickness used in conventional hard card systems is generally limited to certain thick polymers whereas systems of the present invention can use a greater range of material thicknesses and materials including paper, paper and polymer, polymer and polymer, or polymer sheets. Yet another advantage is that systems of the present invention allow for the rapid changing of the size and style for a laminated card. Previous systems, such as conventional hard card systems, are generally provided with the capability for one particular size and style of hard card. Additionally, the durability of a laminated card such as a driver license is limited in conventional hard card system to the durability of dye diffusion inks, which can have poor UV stability. The present invention can be configured for any desired durability requirements.

### BRIEF DESCRIPTION OF THE DRAWINGS

FIG. 1 is a schematic perspective view of a printing system of the present invention showing a card to be printed that is attached to a carrier device in accordance with the present invention;

FIG. 2 is a top view of a portion of the printing system of FIG. 1 showing the card and a portion of the carrier device;

FIG. 3 is a cross-sectional view of the card and carrier device of FIG. 2 taken along the line 3-3.

FIG. 4 is a schematic perspective view of another printing system showing a card to be printed that is positioned in a pocket of a carrier device in accordance with the present invention;

FIG. 5 is a top view of a portion of the printing system of FIG. 4 showing the card and a portion of the carrier device;

FIG. 6 is a cross-sectional view of the card and carrier device of FIG. 5 taken along the line 6-6.

FIG. 7 is a schematic view of a system of the present invention having heated platens that can be used to thermally bond a film to a card showing in particular a card positioned in an opening of a carrier device in accordance with the present invention;

FIG. 8 is a cross-sectional view of a carrier device in accordance with the present invention that can be used to laminate a card in the system of FIG. 7;

FIG. 9 is a schematic view of another system of the present invention having a thermal transfer print head that can be used to thermally bond a film to a card showing in particular a card positioned in a pocket of a carrier device in accordance with the present invention;

FIG. 10 is a top view of a card that can be printed and laminated to have a sealed edge in accordance with the present invention;

FIG. 11 is a top view of a card that can be printed and laminated in accordance with the present invention wherein the corner radius of the card is greater than the corner radius of the covering film;

FIG. 12 is an assembly having an oversize card that is partially attached to an oversize film at an attachment region wherein the card can be printed, thermally bonded to the film, and cut to form a card having a predetermined size in accordance with the present invention;

FIG. 13 is another assembly having a finished size card that is partially attached to a finished size film at an attachment region wherein the card can be printed and thermally bonded to the film to form a card having the finished size in accordance with the present invention;

FIG. 14 is another assembly having a finished size card that is partially attached to an oversized film at an attachment region wherein the card can be printed and thermally bonded to the film to form a card in accordance with the present invention;

FIG. 15 is a front view of a printable surface film that can be printed, folded along a fold line, and bonded to form a card in accordance with the present invention; and

FIG. 16 is a rear view of the printable surface film of FIG. 15 showing in particular a radio frequency identification tag attached to a surface of the film.

### DESCRIPTION

The present invention is directed to secure cards and methods of making such secure cards. Secure cards in accordance with the present invention may include any card that includes secure information. Such cards can also include non-secure information. For example, secure cards may include identification cards and licensing cards, such as those that are carried on the person. Such cards generally comprise information related to a holder of the card such as a photograph, name, address, identification number, and the like.

One such exemplary secure card that can be made in accordance with the present invention is a driver license that is issued by an issuing authority to a recipient. Preferably, in accordance with the present invention, a printer such as an ink-jet printer is used to print driver and license related information on paper stock that is used to form such a driver license. Such information may include security features and recipient related information as described below.

Preferably, the paper stock that is used to form a driver license is close to the size of the finished driver license where it is desired by an issuing authority to print a single driver license at a time. Where there is no requirement to print one license at a time plural driver licenses can be printed on a same sheet.

Typical ink-jet printers require a page size of 4 inches by 5 inches as the smallest size page that can be printed. A typical driver license is 3.375 inches by 2.125 inches. Where an issuing authority requires one driver license to be printed at a time, a single driver license is preferably printed on the smallest page that the printer can handle, such as a 4-inch by 5-inch panel in this example. For materials that are generally low cost and where the cost of the base stock material does not significantly affect the finished driver license cost, then the driver license may be positioned within the 4-inch by 5-inch page in any desired manner and the extra material may be removed and discarded.

Where an issuing authority allows more than one license to be printed on a same sheet, licenses can be preferably arranged on the sheet in order to efficiently use as much of the sheet as desirable to form the licenses. It is noted that any size sheet may be used for any size of license or card. However, it is preferred to minimize waste especially where higher cost materials are used.

The licenses may be separated from the page by any desired technique. For example, licenses may be printed and then cut from the page with a cutting device such as a die cutter to define the boundaries of the license. Also, licenses may be partially pre-cut before printing, such as by using a perforation or any other line of weakness to define some or all of the boundaries of the license. In this way, a license can be separated from the page after printing without the need for an additional cutting operation.

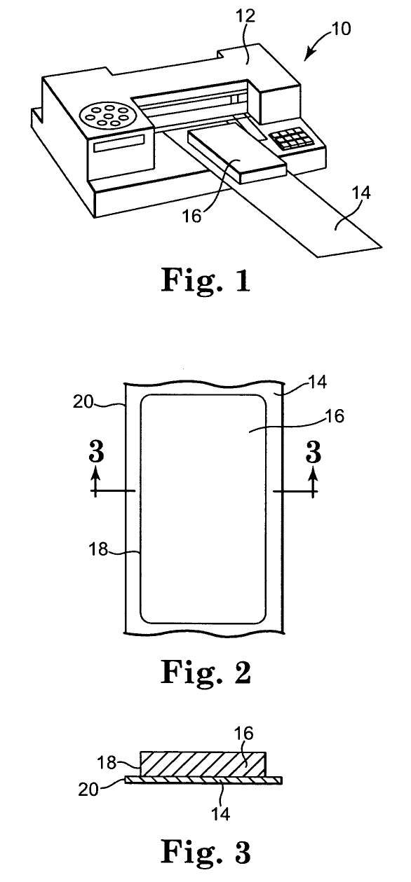

For certain cards, such as those that use more expensive materials, a carrier may be used for transporting the card through a printer. Use of such a carrier allows smaller card stock to be printed by a printer that is designed to print larger sheets. That way, a card may not need to be cut out of a larger sheet and waste of expensive card stock can be reduced or eliminated. Such a carrier preferably functions to positively align a portion of such smaller card stock with a desired feature of a printer such as an edge of a feed mechanism or the like. For example, as shown in FIG. 1, a printing system 10 in accordance with the present invention is shown.

The printing system 10 includes a printer 12 and a carrier 14 for carrying a card 16 through the printer 12 during a printing operation. A top view of the carrier 14 and card 16 is shown in FIG. 2 and a cross-sectional view of the carrier 12 and card 16 is shown in FIG. 3. The carrier 14 preferably comprises a planar substrate material such as a low cost paper or the like to which the card 16 can be attached, such as with a temporary adhesive or the like. An edge 18 of the card 16 is preferably spaced from and is parallel to an edge 20 of the carrier 14 as illustrated. The edge 18 of the card 16 and the edge 20 may be positioned relative to each other in any manner that allows the card 16 to printed in a predetermined manner. As such, the carrier edge 20 can be used to guide the carrier 14 and card 16 through the printer 12 in an aligned manner. The carrier edge 20 can be guided by an edge of the printer feed mechanism or the like for precisely aligning the card 16 to the printer 12. Preferably, the card 16 is attached to the carrier 14 with a repositionable adhesive or other tacky substance or the like so that the card 16 can be easily removed from the carrier 14 after printing. For example, a repositionable adhesive as commercially available from Minnesota Mining and Manufacturing Company of St. Paul, Minn. as used on a variety of “Post-It” products can be used as well as other similar adhesives or tacky or sticky substances. Alternatively, other attachment techniques or devices may be used such as mechanical clips or fasteners or the like.

Some paper stocks that are more durable and capable of higher resolution may also be higher cost. Normally such higher cost paper stock is either a combination of paper and a polymer or all polymer. Usually a polymer is used as the printing surface since it can be made to be smoother than a paper surface. Such a polymeric material typically has an added coating to make it ink jet receptive.

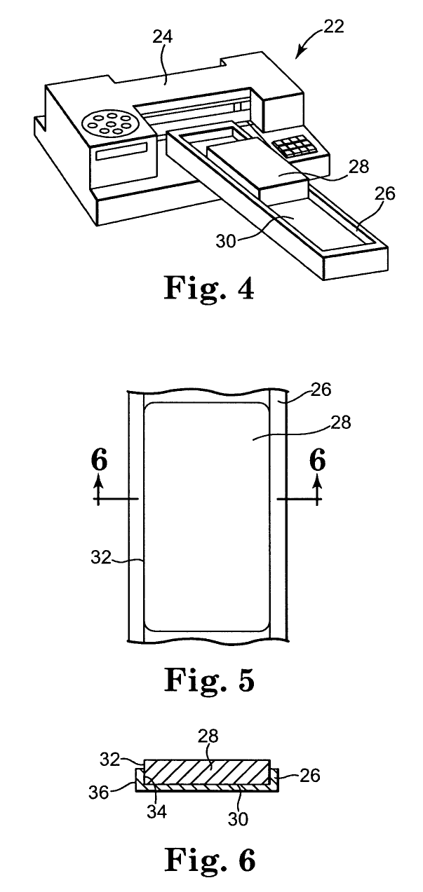

Another printing system 22 in accordance with the present invention is shown in FIG. 4. The printing system 22 includes a printer 24 and a carrier 26 for carrying a card 28 through the printer 24 during a printing operation. A top view of the carrier 26 and card 28 is shown in FIG. 5 and a cross-sectional view of the carrier 26 and card 28 is shown in FIG. 6. The carrier 26 preferably comprises a pocket 30 or recessed region that can receive the card 28. The carrier 26 can be used, in particular, where the card 28 is thick and does not readily travel through the normal feed mechanism of a typical ink-jet printer. For example, many card stocks are typically heavier than the paper that typical ink-jet printers are designed to print and are normally around 0.027 inches. They are sometimes too rigid to travel through the normal feed mechanism path of a printer. Printers such as the Epson Stylus Photo 900 have a straight path option that is generally better suited to a heavy material to be printed.

An edge 32 of the card 28 is preferably aligned with respect to an edge 34 of the pocket 30 of the carrier 26. The edge 34 of the pocket 30 is preferably aligned with respect to an edge 36 of the carrier 26. As such, the carrier edge 36 can be used to guide the carrier 26 and card 28 through the printer 24 in an aligned manner. The carrier edge 36 can be guided by an edge of a printer feed mechanism or the like for precisely aligning the card 28 to the printer 24. The pocket 30 may be shaped to enclose the entire outside edge of the card 28 or may be shaped to enclose one or more predetermined edges of the card 28. Optionally, the card 28 may also be attached to the carrier 26 with a repositionable or releasable adhesive or other tacky substance or the like so that the card 28 can be easily removed from the carrier 26 after printing. Other attachment means such as mechanical fasteners, clips, wires, and the like are contemplated.

Any desired information can be printed on a secure card in accordance with the present invention. This information may include personal information, pictures, and biometric data, and may be coded or include encrypted information if desired. For example, linear or area symbologies, dot codes or bar codes may be used to encrypt information and may be printed on a secure card in accordance with the present invention. An area symbology (or dot code,) as used herein, refers to any symbology, such as those commercially known under the trade names VeriCode™, VSCode™, Data Matrix™, Code One™ or the like, that employ a matrix of data cells, rather than one or more rows of bars and spaces as in a conventional bar code. Certain dot codes such as the dot codes described in U.S. Pat. No. 5,612,524, U.S. Pat. No. 4,924,078, and European Patent No. 0438841 typically require a resolution of at least 600 dpi to be readable when printed with a printer such as an ink jet printer with a code size of 1 inch by 0.75 inches and 3000 dot locations, for example. Certain paper may not give this level of resolution. Paper made to accept high resolution printing such as the Avery C26300-50 is low cost and can provide the required resolution.

Security features can also be printed on secure cards in accordance with the present invention. For example, such security features may includes the use of one or more coded marks as described in applicant's co-pending United States patent application having Attorney Docket No. VER0012/US, entitled “LICENSING AND IDENTIFICATION DEVICES HAVING CODED MARKS AND METHODS OF MAKING AND AUTHENTICATING SUCH LICENSING AND IDENTIFICATION DEVICES,” to Huimin Sunn et al., filed on the same date as the subject application, the entire contents of which are fully incorporated herein by reference for all purposes. In any case, any desired security features may be printed or otherwise provided on a secure card in accordance with the present invention.

Driver licenses and other personal documents such as identification cards are normally kept on the person and are subject to physical and chemical wear. Some applications are for short time periods such as temporary cards and do not require long-term capability. All such cards preferably withstand some attack from oils (such as from human skin), water based and solvent chemicals, abrasion, sunlight, and the like. Cards formed in accordance with the present invention may use a system of oil or solvent and oil based ink jet inks to overcome some of the durability issues seen in water-based inks. Water based inks may also be used.

Applications that require long term durability may need to use a polymer substrate, oil or solvent and oil based ink jet inks as well as a protective clear film. This combination can provide the results described below. Resistance to chemicals including water based cleaners, mild solvents, automotive chemicals such as gasoline and brake fluid, alcohols and other chemicals normally used by automobile owners such as for cleaning purposes and the like can be provided because either the film or the coating process provides protection from the noted chemicals. A non-protected card that is resistant to water based cleaners can be provided if printed with solvent-based inks. While a film or a coating process provides a high level of protection from abrasion, a card printed with solvent based inks can provide reasonable resistance to abrasion.

Resistance to UV exposure from sun light can also be provided. Some formulations of ink jet inks have good UV resistance while both a coating and a film layer can have UV inhibitors. Resistance to tampering by removal of a clear coating can also be provided because the coating cannot be removed without damaging the card. Resistance to deterioration of a base card by water such as in a washing machine, for example, can also be provided. This is because a polymer-based card can be waterproof as are the solvent-based inks that can be used and such a card will go through a washing machine cycle without damage.

For the applications that require the addition of a clear layer to the base material, a clear polymer top film with hot melt adhesive can be used and a clear polymer coating using a mass thermal transfer ribbon or hot stamp thermal transfer ribbon can be used. Both methods are suitable for paper stock and relatively thicker card stock substrates. Because potential surfaces requiring adhesion are polymers, papers, and ink jet receptive coatings, the exact formulation for a hot melt coating is preferably optimized for a particular paper or card stock.

As an example a card that is 3.375 inches by 2.125 inches with rounded corners can be used and preferably die cut. A protective covering film is also preferably cut to 3.375 inches by 2.125 inches with rounded corners. The protective covering film preferably comprises thermoplastic properties such as by including a hot melt adhesive layer or the like. However, the card or film can be any size that fits in a desired printer. In order to laminate the film to the card, a mechanism is preferably used that uses a heated platen followed by pressurized rubber rollers driven by an electric motor (laminator). The rollers preferably apply pressure to the film and the paper or card stock while the film is heated. The rolling action preferably removes air from the bonding interface and forms the bond at the interface of the film adhesive and the card. As such, the card and film continue to move forward under a cooling platen and exit as a finished product. While in the laminator, the card and film are preferably encased in a folded paper sheath to protect the laminator. Because the laminator rollers might apply uneven stress at the leading edge of the card and film, the positioning of the film on the card may change during the lamination cycle.

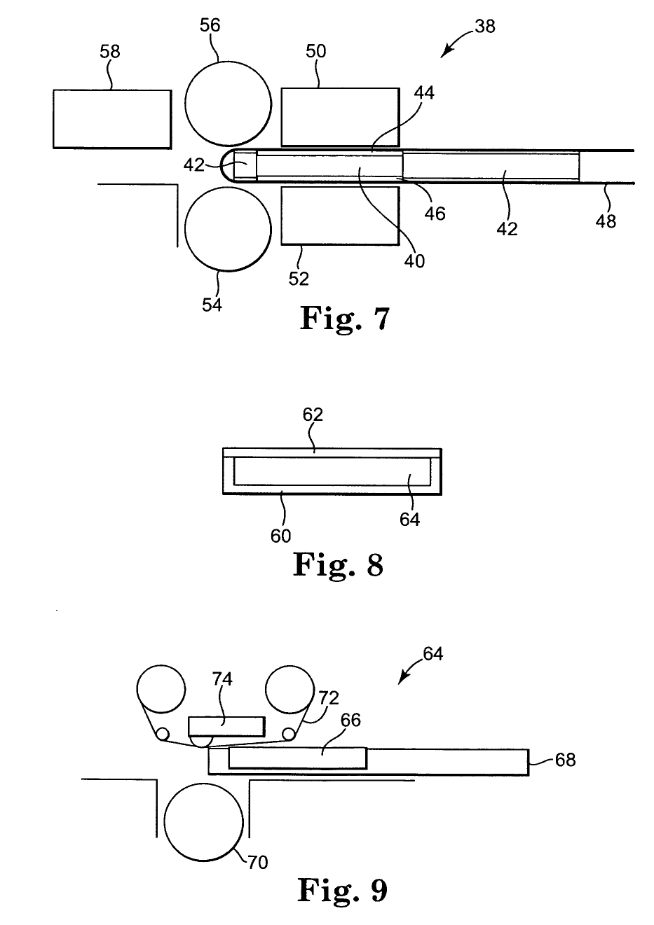

FIG. 7 schematically shows a lamination system 38 for laminating secure cards in accordance with the present invention. As shown, card 40 and first and second films, 44 and 46, are positioned in a carrier 42. The carrier 42 is wrapped in a protective sheath 48. The lamination system 38 also includes first and second heated platens, 50 and 52, first and second rollers, 54 and 56, and a cooling platen 58. As the rollers, 54 and 56, draw the carrier 42 through the system 38, the heated platens, 54 and 56, heat the films, 44 and 46, and pressure applied by the rollers, 54 and 56, laminates the films, 44 and 46, to the card 40. By using the carrier 42 in this manner, the film, 44 and 46, can be aligned to the card 40 and held in place during the lamination process. The carrier 40 enters the rollers, 54 and 56, before the films, 44 and 46, and card 40 which equalizes pressure thereby providing an improved quality of lamination. As shown, both surfaces of the card 40 are laminated, however, a single surface may be laminated in the same way. It is not required to laminate both surfaces of the card 40.

Some applications require a card to be sealed inside the top and bottom films including an edge seal. Paper card stock can be made water resistant by sealing edges of the card stock thereby not allowing water penetration. One problem may be getting good alignment of the card stock and a sealing film. There can also be a problem where the card stock has a non-uniform thickness that can cause film edges to bridge while being laminated. Such bridging can provide the start of leaks that allow water penetration. In order to avoid these problems the card 40 may be laminated on both sides and all edges. One exemplary way to do this is shown in FIG. 8, which shows films, 60 and 62, that can be used to enclose a card 64 as shown. This assembly can be laminated by the lamination system 38 with or without the use of a carrier. The film 60 can function as the carrier.

Some applications do not use pre-cut or use perforated card stock to define outer edges of a card. For example, card stock being used may not be suitable for die cutting or the cost of die cutting may be prohibitive. Generally, as long as a printer images the same area each time, die cutting can be accomplished after a printing process. Die cutting card stock without a film, card stock with a top film, or card stock with a top and bottom film can provide a better edge than laminating pre-die cut materials. Any known or developed cutting technique can be used, such as hot or cold die cutting as well established. Preferably, printed information is aligned in a predetermined manner to an edge of a card when cutting a card.

Some applications do not use a film lamination method of coating a card with a clear film as described above. While a clear film provides excellent protection, some cards do not do well in the heated environment of a heat laminator because of curling or otherwise changing shape. The cost of film is typically higher than ribbon coatings, which is also a consideration. Another system 64 that can be used to provide a coating on a secure card in accordance with the present invention is shown in FIG. 9. As shown, a card 66 is provided in a carrier 68. A drive roller 70 moves the carrier 68 and card 66 through the system 64. A transfer ribbon 72 that includes a coating material to be applied to the card 66 is positioned above the card 66 as shown. As the card 66 moves through the system 64, a thermal transfer print head 74 applies heat to the ribbon 72 thereby transferring the coating on the ribbon 72 to the card surface. A thermal transfer or hot stamp ribbon system preferably uses a resin-based combination of binder as the coating and a wear layer in a single or multiple layered construction. The coating is preferably layered on a polyester carrier film that can be applied to the card 66 by using heat and pressure. The heat and pressure release the coating from the polyester carrier film and bond the coating to the card. Generally, the thickness of the coating is much less than the lamination process described above.

This process can allow the print head 74 to come up to the proper heat level before printing on the card 66 and provides consistent pressure on the leading edge of the card 66. The carrier 68 can be made from a low energy polymer such as Delrin or Teflon and can be coated with release agents to prevent the buildup of coating on the carrier 68 if it is to be reusable. Exemplary carriers that may be used are described above with respect to FIGS. 1 and 4, for example.

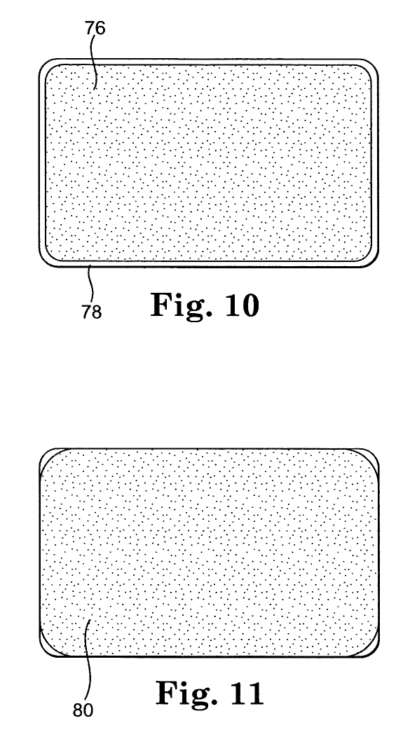

For some top films and card stocks the adhesion between a top film and card stock is low or a top film and card stock are both very tough making delamination more likely. Most delamination starts at a corner and works in from the corner. This problem is often seen on products that are carried in purses, billfolds, pants pockets, or in other ways where the corner is stressed. One solution is to increase adhesion at a weak point such as around an edge of the card. For example, referring to FIG. 10 a card 76 can be surrounded by a clear protective film on the front and back so that there is an overlap region 78 around an outside edge of the card 76. For a typical driver license the overlap region 78 may be about 2 mm, for example. The clear protective film is preferably bonded to itself around the overlap region 78 thereby sealing the card 76 and providing good edge and corner protection. Another solution is to increase adhesion at a weak point such as at a corner of a card. For example, referring to FIG. 11, a card 80 is shown wherein a corner radius of the card 80 is larger than a corner radius of a film sealed to the card 80. This provides an area where a top film will seal to a back film creating a strong bond. The corners can be better protected from delamination by this method.

Time and production costs can be saved by pre-assembling components before delivery to the a particular user or consumer. Pre-assembly avoids alignment issues and reduces the time to make a finished card. The present invention also provides pre-assembled structures that include a card stock and a top and bottom film such as the examples set forth below.

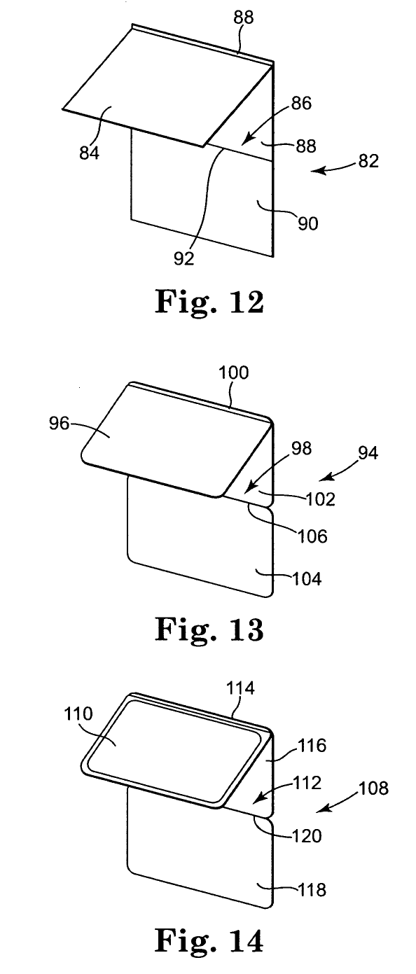

In FIG. 12, one exemplary pre-assembled structure 82 that can be used to form a secure card in accordance with the present invention is shown. The structure 82 includes a card 84 that is attached to a film 86 at an attachment region 88 along an edge of the card 84 and film 86. The card 84 can be attached to the film 86 by any means such as by heat sealing adhesive or the like. For example, a heat sealed region of about 2.5 mm wide may be used. The film 86 preferably includes first and second portions, 88 and 90, respectively, preferably separated by a fold line 92. A perforated or score line may be used as the fold line 92 to make it easy to fold the first portion 88 relative to the second portion 90.

Preferably, the card 84 and the first and second portions, 88 and 90, are oversized so that alignment of the card 84 and the first and second portions, 88 and 90, is not critical. In use, information can be printed on the card 84 as described above. The first and second portions, 88 and 90, of the film 86 can be folded at the fold line 92 in order to position the first and second portions, 88 and 90, of the film 86 on either side of the card 84. The first and second portions, 88 and 90, of the film 86 can then be laminated to the card 84 as is described above, for example. The laminated structure can then be cut to any desired size.

In FIG. 13, another exemplary pre-assembled structure 94 that can be used to form a secure card in accordance with the present invention is shown. The structure 94 includes a card 96 that is attached to a film 98 at an attachment region 100 along an edge of the card 96 and film 98. The card 96 can be attached to the film 98 by any means such as by heat sealing adhesive or the like. For example, a heat sealed region of about 2.5 mm wide may be used. The film 98 preferably includes first and second portions, 102 and 104, respectively, separated by a fold line 106. A perforated or score line may be used as the fold line 106 to make is easy to fold the first portion 102 relative to the second portion 104.

Preferably, the card 96 and the first and second portions, 102 and 104, are provided with a finished size. As such, the card 96 is preferably aligned with the first and second portions, 102 and 104, when the card 96 is attached to the film 98. In use, information can be printed on the card 96 as described above. The first and second portions, 102 and 104, of the film 98 can be folded at the fold line 106 in order to position the first and second portions, 102 and 104, of the film 98 on either side of the card 96. The first and second portions, 102 and 104, of the film 98 can then be laminated to the card 96 as is described above, for example. The laminated structure can then be cut to any desired size.

In FIG. 14, another exemplary pre-assembled structure 108 that can be used to form a secure card in accordance with the present invention is shown. The structure 108 includes a card 110 that is attached to a film 112 at an attachment region 114 along an edge of the card 110 and film 112. The card 110 can be attached to the film 112 by any means such as by heat sealing adhesive or the like. For example, a heat sealed region of about 2.5 mm wide may be used. The film 112 preferably includes first and second portions, 116 and 118, respectively, separated by a fold line 120. A perforated or score line may be used as the fold line 120 to make is easy to fold the first portion 116 relative to the second portion 118.

Preferably, the card 10 is provided with a finished size and the first and second portions, 116 and 118, are oversized. By oversizing the first and second portions, 116 and 118, a sealed edge can be provided around the perimeter of the card 110. As such, the card 110 is preferably aligned with the first and second portions, 116 and 118, when the card 110 is attached to the film 112. In use, information can be printed on the card 110 as described above. The first and second portions, 116 and 118, of the film 112 can be folded at the fold line 120 in order to position the first and second portions, 116 and 118, of the film 112 on either side of the card 110. The first and second portions, 116 and 118, of the film 112 can then be laminated to the card 110 as is described above, for example. The laminated structure can then be cut to any desired size. A die cut perforation between a top and bottom film can help in folding the top film back over the card stock while maintaining good alignment.

In another aspect of the present invention methods for printing information on both a front side and a backside of a card such as a driver license or other secure or non-secure documents or the like are provided. More particularly, the present invention provides methods to print information on a front side and a back side of a card or other secure or non-secure documents in a single pass through a printing device while maintaining a desired predetermined size for such a card. Also, methods for providing preprinted graphics on both a front side and a backside of a card or other secure or non-secure documents are provided in accordance with the present invention. For example, materials that are pre-printable by using techniques such as letter press, rotary press, flexographic press and the like can be used. In addition, another aspect of the present invention provides the ability to have electronically held information in cards such as driver licenses or other secure or non-secure documents by using RFID (Radio Frequency Identification) transponders or other such electronic/passive devices. One exemplary transponder is made by Texas Instruments Corp of Texas, USA with the product designation RI-I02-112A.

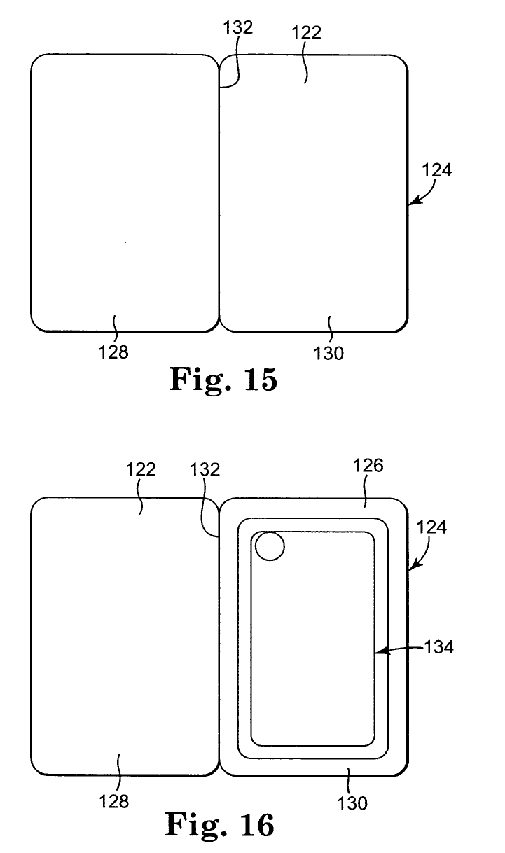

With reference to FIGS. 15 and 16, methods for making such cards are described below. In FIG. 15 a front side 122 of a printable stock film 124 is shown and in FIG. 16 a rear side 126 of the printable stock film 124 is shown. The printable stock film 124 includes first and second portions, 128 and 130, separated by a fold line 132. As shown in FIG. 16, the second portion 130 includes a radio frequency identification (RFID) transponder, which is described below. Preferably, a printable stock film with the characteristics described below is used. The front side 122 preferably comprises an ink jet printable surface or other digital printing receptive surface. While this surface may be a coating on the polymer or paper film or sheet any digitally printable surface, any known or future developed materials having such a printable surface may be used in accordance with the present invention.

At least a portion of the rear side 126 of the printable stock film 124 preferably comprises an adhesive system allowing the joining of one backside to another backside while not affecting the ability of the material to go through a printing device such as a digital printer. A hot melt coating can be used but other adhesive systems including coatings, pressure sensitive adhesives with liners, transfer adhesives, reactive adhesives and polymers that can seal to themselves are also contemplated. Such adhesive may be provided on one surface or both surfaces to be adhered to each other. An adhesive can be provided on any portion of the surface so that sufficient bonding can be achieved.

The material preferably comprises a thickness and flexibility that is printable using any conventionally known or future developed bulk printing techniques such as letter press, rotary letter press, flexographic and the like.

The printable stock film can be die cut to a form a shape with two parts that when folded on a fold line between the two parts results in a desired shape for the card such as a driver license or other secure or non-secure document.

A top side and/or back side laminate preferably comprises a polymer film and an adhesive system. The polymer film preferably protects the card or other secure or non-secure documents from environmental damage and attempts to alter the printed information (as a security feature). The laminate can be in any form such as is described above.

A printable stock film (PS film) preferably allows for ink jet or other digital printing of one side of the film and for bonding on a reverse side of the film. In the manufacturing process for the PS film both the front side and the backside of the film can be pre-printed using various means including letter press, rotary letter press and flexographic press as well as any other known or future developed printing techniques capable of printing on such films in accordance with the present invention. The pre-printing can come before or after the application of ink jet or other digital printer colorant receptive surfaces and adhesion coatings if required. As described above, visual and covert security markings and other measures can also be added during the manufacturing process to one or both sides of a PS film. After any desired coatings and pre-printing are provided, the PS film is preferably die cut to shape although any cutting/shaping technique in accordance with the present invention may be used. The cut shape along with a perforation or partial depth die cut or score line separating the two sections allow the PS film to be printed, folded and laminated together quickly without the extra steps of separating sections or post lamination die cutting.

Because both a front side and backside outer surface of a card or other secure or non-secure document are on a single plane, both the front side and the backside can be printed in a single pass in accordance with the present invention. This allows for convenient, fast printing of information, graphics and coded marks or symbols to be printed in a single pass on both the front side and backside. The preprinted graphics can provide visual and covert security markings, micro-print, hard to forge color imaging such as seen on currency, high quality customer graphics and the like using preprinted graphics can also speed up the print process by reducing the print area while also reducing the usage of colorant. In one aspect of the present invention, the size of a PS film is twice as large as a finished card. In the example above, the PS film is 3⅜ inches by 4¼ inches and the finished card is 2⅛ inches by 3⅜ inches (such as for forming a typical driver license or identification card) however a card can be made with any desired dimensions. Any suitable printer that can receive a PS film with the desired size can be used. For example, printers such as the Epson C63 will accept 3½ inch wide film and may be used in accordance with the present invention. Any conventionally known or future developed printing device may be used for any card having any desired size.

Once printed, a PS film can be folded and laminated by any desired technique or placed in a top side and/or back side laminate and laminated. While many methods can be used to provide the bonding of the various surfaces within the scope of the present invention, one preferred method is heat bonding. Many variations of the components and methods of carrying components through a heated roll laminator are discussed in detail above. As described above, some of the components and lamination methods can be used to help in the alignment of a PS film and a laminate film/s to assure a quality lamination without subjective alignment by eye. It is also contemplated to use an over sized laminate to hold the front side and the back side of a PS film together making the PS film back side bonding unnecessary.

The present invention also provides methods of inserting a RFID or other transponders into a bonded junction or interface of a PS film. A RFID or other transponder can be any device that will store information that is transferable with out physical contact and is of such a size and thickness that will allow insertion between two adhesive sides of a printable stock film. Such devices are often generically identified as tags. The invention is not dependent on the use of a protective laminate.

A tag can be adhered to a surface of a PS film by spot heating the tag to a hot melt adhesive as an example. Preferably the tag is thin so that the assembly of PS film and tag will carry through a digital printer acceptably. The tag can also be manually placed in a folded PS film before lamination but after printing.

A tag and a coded mark can be used together to provide features not available separately. A tag can contain information that is generally changeable such as time/date data, money transactions, personal data such as phone numbers that may change while a coded mark (such as and area symbology or bar code or the like) can hold permanent data such as finger print data, a facial image and the like. Tag information is not visible and changes can not be seen where a coded mark is visual and attempts to alter such a mark are readily visible. A coded mark can contain more data at less cost while a less costly, smaller memory tag can be used in combination with a coded mark to lower total costs requiring both permanent and rewriteable data. A tag is readable at a distance but does not have the security of individual biometric identification. A tag and coded mark together provides both for applications with varying security needs. A tag and coded mark together make forgeries much more difficult than either alone because of the multiple technologies and expertise needed to decrypt the two different coding means.

A tag (if a RFID transponder) can have fixed data as well as rewriteable data. The number of bites of data is normally limited to 2000 bites for common tags. Tags holding more data are available but at a much higher cost than those with 2000 bites. Reading data from a tag takes considerably longer than reading a coded mark with the same number of data bites. A coded mark cannot be rewritten once printed on a driver license or other secure or non-secure document. A two-dimensional coded mark, such as an area symbology, can hold 10,000 or more bytes of data. A tag can be read without line of sight and remotely such as when entering a building through an RFID antenna array while the coded mark requires a fixed location to be read.

The total data available by a coded mark is preferably large enough to contain biometric information and cardholder data. The type of information and data best served by coded mark is data that will not change such as a finger print identification and personal data such as eye color, driver license identification number and the like. The data types best reserved for a tag are those that may change such as an address, driving record, payment data and the like. With a coded mark and tag on a driver license or other secure or non-secure document a large volume of data and changeable information and fixed data can be held concurrently.

Both a coded mark and tag can be read concurrently allowing important information or data to be held in redundant sections of each to assure the accuracy of the read. If tampering is attempted the possibility of changing two highly secure data locations is much less than changing one location. Tampering attempts on visual codes are easier to detect than electronic changes to a tag. If tampering is attempted by replacing an entire tag or coded mark the technology to do both is much more difficult than replacing one. The same is true of forging a entire driver license or other secure or non-secure document. Having both a tag and a coded mark make usable forgeries highly difficult if not impossible. Both a tag and coded mark can be read concurrently making the best use of extracting volume fixed data from a coded mark at higher speed while reading lesser variable data at slower speeds from a tag. A tag can be used as a general entrance control while a coded mark can be used for higher security areas where positive identification is required all in one driver license or other secure or non-secure document. A tag and coded mark combination offers high security while costing less than currently available similar devices and production methods in accordance with the present invention are easy to produce using common, low cost hardware.

The present invention may use the following set of materials, devices and/or processes:

Paper, paper and polymer, polymer and polymer, or polymer sheets such as vinyl polymer sheets up to 0.055 inches in thickness, for example, coated with an ink jet receptive layer that accepts ink jet inks made from water, oil or solvent/oil.

Paper, paper and polymer, polymer and polymer or polymer sheets up to 0.016 inches in thickness, for example, coated with ink jet receptive layer that accepts ink jet inks made from water, oil or solvent/oil denoted as paper stock.

Clear mass thermal transfer durable polymer ribbon or clear hot stamp ribbon applied as a top coating for vinyl substrate by use of a mass thermal transfer printer.

A vinyl, polyester or other polymer sheeting coated with a hot melt adhesive that is applicable to the vinyl or other card stock or paper stock surfaces applied by heat transfer means.

Ink jet printers such as the Epson Stylus Photo 900, for example.

Mass thermal transfer printers such as the Sato CX series of printers and any printers that function in a similar manner, for example.

Heat roll laminators such as the Ibico EL12 heat laminator as well as any laminators that function in a similar manner, for example.

The present invention has now been described with reference to several embodiments. The foregoing detailed description has been given for clarity of understanding. Others may recognize that changes can be made in the described embodiments without departing from the scope and spirit of the invention. Thus, the scope of the present invention should not be limited to the exact details and structures described herein.

1. A method for making a secure card to be issued to a recipient, the method comprising the steps of:
providing a substrate having at least one surface capable of being printed by an ink-jet printer;
printing recipient-specific information on the at least one surface of the substrate with an ink-jet printer; and
thermally bonding a film to at least one surface of the substrate while the substrate is positioned in a pocket of a carrier device.

2. The method of claim 1, wherein the step of printing recipient-specific information comprises carrying the substrate through the ink-jet printer with a carrier device.

3. The method of claim 2, comprising the step of adhering the substrate to the carrier device with a removable adhesive.

4. The method of claim 2, comprising the step of positioning the substrate in a pocket of the carrier device.

5. The method of claim 1, wherein the step of thermally bonding a film comprises laminating a clear film onto the at least one surface of the substrate.

6. The method of claim 1, wherein the step of thermally bonding a film comprises transferring a clear film onto the at least one surface of the substrate with a thermal transfer print head.

7. The method of claim 1, further comprising the step of providing a coded two-dimensional symbol on the at least one surface of the substrate.

8. The method of claim 1, further comprising cutting the substrate to have a predetermined size and shape.

9. The method of claim 1, further comprising attaching a radio-frequency identification tag to the substrate.

10. The method of claim 9, comprising sandwiching the radio-frequency identification tag between first and second portions of the substrate.

11. An apparatus for coating a card with a film, the apparatus comprising:
a carrier for carrying a card in a machine direction, the carrier comprising a pocket for holding the card;
a ribbon comprising a coating to be applied to the card as a film, the ribbon operatively positioned relative to a card when carried by the carrier; and
a thermal transfer print head positioned relative to the ribbon for transferring the coating from the ribbon to the card.

12. A method of making a card, the method comprising the steps of:
providing a film having first and second portions, the first portion for forming a front side of the card and the second portion for forming a rear side of the card;
printing predetermined information on both of the first and second portions of the film;
providing a radio-frequency identification tag on at least a portion of the card; and
folding the film along a predetermined fold line to form the card.

13. The method of claim 12, wherein the folding step comprises securing the first and second portions together to form the card.

14. The method of claim 12, comprising at least partially laminating the card.

15. The method of claim 12, comprising die cutting the film to have a predetermined size and shape.
